(19) United States
(12) Patent Application Publication
(10) Pub. No.: US 2026/0131583 A1
(43) Pub. Date: May 14, 2026

(54) RECORDING DEVICE

(71) Applicant: CANON KABUSHIKI KAISHA, Tokyo (JP)

(72) Inventor: CHO RYO, Kanagawa (JP)

(21) Appl. No.: 19/379,189

(22) Filed: Nov. 4, 2025

(30) Foreign Application Priority Data
Nov. 11, 2024 (JP) 2024-196704

(51) Int. Cl. B41J 15/04; B41J 11/00; B41J 15/02; B41J 29/393; B41J 29/46

(52) U.S. Cl. CPC B41J 15/04; B41J 11/0095; B41J 15/02; B41J 29/393; B41J 29/46

(57) ABSTRACT

A recording device includes a holding unit configured to hold a roll sheet in which a recording medium is wound in a roll shape, a conveyance unit configured to unwind and convey the recording medium from the roll sheet held by the holding unit, a recording unit configured to perform recording on the recording medium conveyed by the conveyance unit, and a control unit configured to perform the conveyance of the recording medium by the conveyance unit and control of the recording by the recording unit. The recording device further includes a setting unit configured to set splice information related to a position of a splice which is a joint of the roll sheet held by the holding unit, and the control unit performs the control by the splice information set by the setting unit.

### BACKGROUND

### Field of the Technology

The present disclosure relates to a recording device.

### Description of the Related Art

A printing device using a long recording medium such as roll paper or a roll film is known. When such roll paper is manufactured, recording media may be connected to each other with a tape depending on a length of original material and a length of inventory, and a joint or seam at this time is also called a “splice”. According to such a manufacturing method, it is possible to provide roll paper at relatively low cost and with a short delivery time by utilizing a recording medium having a short length.

However, when ink is ejected onto a portion of the splice during printing, there is a possibility that ink overflow occurs. Also, there is a possibility that the splice portion rubs against a print head during conveyance of the recording medium and print quality is affected.

Thus, in a case where the roll paper having the splice is used, it is conceivable to detect before the splice passes under the print head. For example, Japanese Patent Laid-Open 2003-246106 discloses a printing device that retracts a print head from roll paper when a splice is detected, conveys a certain amount of roll paper, and then returns the print head onto the roll paper to restart image recording. Japanese Patent Laid-Open 2020-117344 discloses a printing device that performs blank paper printing on a splice page in a case where printing is performed by connecting recording media.

However, in the printing device described in Japanese Patent Laid-Open 2003-246106 and Japanese Patent Laid-Open 2020-117344, the printing on the splice can be prevented, but there is a problem that printing of a job scheduled to be continuously printed is interrupted in the middle, and a consolidated output cannot be obtained. As described above, it is desirable that the splice is not included in the job scheduled to be continuously printed.

### SUMMARY

The present disclosure has been made to solve the above problems, and an object thereof is to appropriately manage a position of a splice in continuous printing.

The present disclosure provides a recording device comprising:
a holding unit configured to hold a roll sheet in which a recording medium is wound in a roll shape;
a conveyance unit configured to unwind and convey the recording medium from the roll sheet held by the holding unit;
a recording unit configured to perform recording on the recording medium conveyed by the conveyance unit; and
a control unit configured to perform the conveyance of the recording medium by the conveyance unit and control of the recording by the recording unit,
wherein the recording device further includes
a setting unit configured to set splice information related to a position of a splice which is a joint of the roll sheet held by the holding unit, and
the control unit performs the control by the splice information set by the setting unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a device configuration of an image forming system.

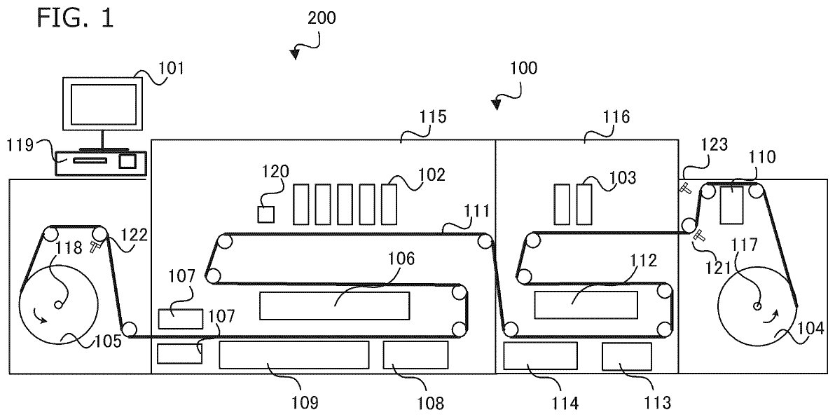

FIG. 2 is a block diagram illustrating functions of the image forming system.

FIG. 3 is a flowchart until the start of printing.

FIG. 4 is an example of a UI screen on which a list of print jobs is displayed.

FIG. 5 is an example of a UI screen on which a registration screen for setting a splice position is displayed.

FIG. 6 is a sectional view of roll paper.

FIGS. 7A and 7B illustrate a method for calculating a roll paper length from a roll paper radius.

FIG. 8 is a diagram illustrating continuous usable length display.

FIG. 9 is an example of a UI screen for print confirmation.

FIG. 10A is an example of the UI screen for print confirmation.

FIG. 10B is an example of the UI screen for print confirmation.

FIG. 10C is an example of the UI screen for print confirmation.

FIG. 11A is an example of the UI screen for print confirmation.

FIG. 11B is an example of the UI screen for print confirmation.

FIG. 11C is an example of the UI screen for print confirmation.

FIG. 12 is a flowchart until the start of printing for obtaining optimization of a print order.

FIG. 13A is an example of a UI screen for optimizing the print order.

FIG. 13B is an example of the UI screen for optimizing the print order.

FIG. 13C is an example of the UI screen for optimizing the print order.

FIG. 14 is an example of a label attached to roll paper delivered from a paper manufacturer.

### DESCRIPTION OF THE EMBODIMENTS

Hereinafter, embodiments of the present disclosure will be described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

### First Embodiment

### (Device Configuration)

A first embodiment of the present disclosure will be described. First, a configuration of an image forming system 200 will be described. The image forming system 200 includes an image forming apparatus 100 and a control PC 119. The image forming apparatus 100 is an apparatus that forms an image on roll paper 111 that is continuous paper capable of continuously forming an image. The image forming apparatus 100 includes a paper feeding device 104 that conveys the roll paper 111, a recording unit 116 (special color recording unit) that performs special color printing, a recording unit 115 (basic color recording unit) that performs basic color printing, a paper discharging device 105 that winds the roll paper 111, and a UI operation panel 101 as a setting unit. The setting of splice information may be a method for acquiring and setting the splice information by a sensor after a roll sheet is unwound.

The roll paper 111 is a roll sheet having a shape in which an elongated recording medium having a substantially constant width is wound in a roll shape (cylindrical shape). The roll paper 111 is generally formed by winding the recording medium around a tubular core with the core as a center. Although the roll paper is referred to as “paper” for the sake of convenience, a recording medium other than paper such as a film may be used. A paper tube is usually used as the core, but the core is not limited thereto as long as the paperboard core is a tubular member.

The paper feeding device 104 is a device that supplies the roll paper 111 to the image forming apparatus 100. The paper feeding device 104 is a holding unit that holds the roll sheet. The holding unit may have a form in which the roll sheet is placed. The paper feeding device 104 rotates a paperboard core 601 of the roll paper 111 in an arrow direction around a rotation shaft 117. As a result, the roll paper 111 wound around the paperboard core 601 is unwound and conveyed toward the image forming apparatus 100 at a constant speed via a plurality of rollers (a conveyance roller, a paper feeding roller, and the like).

The paper discharging device 105 is a device that winds the roll paper 111 conveyed from the image forming apparatus 100. The paper discharging device 105 winds the roll paper 111 in the arrow direction around the paperboard core 601 of a rotation shaft 118 and holds the roll paper in a roll shape. The paper discharging device 105 winds the conveyed roll paper 111 around the rotation shaft 118 at a constant speed via a plurality of rollers (for example, a conveyance roller and a sheet discharge roller).

A remaining amount detection sensor 121 (paper-feeding-side remaining amount detection sensor) measures an outer diameter of the roll paper 111 set in the paper feeding device 104. The remaining amount detection sensor 122 (paper-discharging-side remaining amount detection sensor) measures an outer diameter of the roll paper 111 set in the paper discharging device 105.

Before the start of printing, the roll paper 111 is passed from the paper feeding device 104 to the paper discharging device 105. The description regarding up, down, left, and right in the following description merely indicates a positional relationship on a paper surface. Specifically, first, the roll paper 111 is set in the paper feeding device 104, and a leading end of the roll paper 111 is passed above a skew correction device 110 and under a printing device 103 (recording device) of the recording unit 116 in this order. The printing device 103 (special color printing device or special color recording device) that is a recording unit in the present embodiment is a device that prints special colors (for example, white ink and the like) other than print basic colors (CMYK).

Subsequently, the leading end of the roll paper 111 is passed under a drying device 112 of the recording unit 116 and above cooling devices 113 and 114 in this order. Subsequently, the leading end of the roll paper 111 is passed under a mark sensor 120 of the recording unit 115, under a printing device 102 (recording device), under the drying device 106, and above the cooling devices 108 and 109 in this order. The printing device 102 (basic color printing device or basic color recording device) that is a recording unit in the present embodiment is a device that prints print basic colors (CMYK). Subsequently, the leading end of the roll paper 111 is passed through a scanner device 107 and then wound around the paper discharging device 105.

After the roll paper 111 passes in the image forming apparatus 100 as described above, a user inputs a print job to the control PC 119 of the image forming system 200. After the print job is input, a print start button is pressed on the UI operation panel 101 to start printing.

A splice detection sensor 123 detects a splice present on the roll paper 111. For example, in a case where the splice is detected by the splice detection sensor 123 during printing, printing is immediately interrupted. Thereafter, the paper feeding device 104 automatically conveys the splice to the paper discharging device 105, and ends printing. For example, an optical sensor including an irradiation unit that irradiates the roll paper 111 with light and a light receiving unit that receives reflected light and performing detection based on the intensity of the reflected light can be used as the splice detection sensor 123. However, the splice detection method is not limited thereto.

When the roll paper 111 on which the image is printed is conveyed, the scanner device 107 reads the image, and the control PC 119 performs analysis of the read image to inspect whether or not there is a defect in a printed matter.

### (Control Configuration)

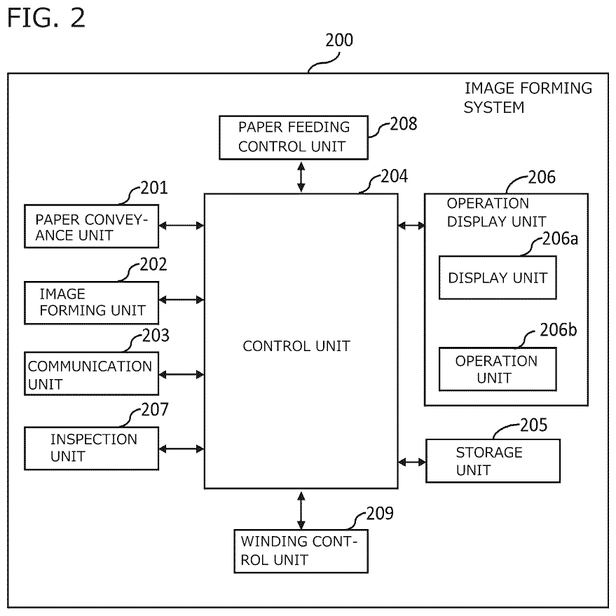

Next, a control configuration of the image forming system 200 will be described in detail. FIG. 2 is a functional block diagram illustrating a control configuration of the image forming system 200.

The image forming apparatus 100 includes a paper conveyance unit 201, an image forming unit 202, a communication unit 203, a control unit 204, a storage unit 205, an operation display unit 206, an inspection unit 207, a paper feeding control unit 208, and a winding control unit 209. The configuration related to the control of the control unit and the like may be provided on a body side of the image forming apparatus 100 or may be provided on the control PC 119 side.

The paper conveyance unit 201 is a conveyance mechanism of the roll paper 111 inside the image forming apparatus 100. For example, the roll paper 111 conveyed from the paper feeding control unit 208 is conveyed to the image forming unit 202 by a plurality of rollers, and the roll paper 111 having passed through the image forming unit 202 is conveyed to the winding control unit 209. The paper conveyance unit 201 physically includes a conveyance roller, a paper feeding roller, a conveyance path, and the like.

The image forming unit 202 forms the image on the roll paper 111 supplied from the paper feeding control unit 208 on the basis of print data of the print job. The roll paper 111 on which the image is formed by the image forming unit 202 is conveyed by the paper conveyance unit 201 toward the winding control unit 209. The image forming unit 202 physically includes at least the printing devices 102 and 103. The image forming unit 202 may further include some or all of the configurations for forming the image on the roll paper 111, for example, the drying devices 106 and 112, and the cooling devices 108, 109, 113, and 114. The paper feeding control unit 208 and the winding control unit 209 physically correspond to the paper feeding device 104 and the paper discharging device 105, respectively.

The communication unit 203 includes, for example, a communication control card such as a local area network (LAN) card. Transmission and reception of various kinds of data to and from an external device connected to a communication network such as a LAN or a wide area network (WAN) are performed. The external device may be, for example, the control PC 119 of the image forming system 200 or an external PC.

The control unit 204 includes, for example, a central processing unit (CPU), a random access memory (RAM), and the like. The CPU of the control unit 204 reads various programs such as a system program and a processing program stored in the storage unit 205, loads the programs into the RAM, and executes various kinds of processing according to the loaded programs. For example, the control unit 204 executes image forming processing of executing a print job (hereinafter, also simply referred to as a job) in accordance with an instruction of the user. The storage unit 205 includes, for example, a nonvolatile semiconductor memory (so-called flash memory), a hard disk drive (HDD), or the like. The storage unit 205 stores various programs including a system program and a processing program executed by the control unit 204, and various kinds of data necessary for executing these programs.

The operation display unit 206 includes, for example, a liquid crystal display (LCD) with a touch panel, and includes a display unit 206a and an operation unit 206b. The display unit 206a displays various kinds of information on a display screen according to a display control signal input from the control unit 204. The operation unit 206b includes various operation keys such as a numeric keypad and a start key, receives various input operations by the user, and outputs operation signals to the control unit 204. In the operation display unit 206, the control unit 204 can perform job printing processing, other various settings, and the like. For example, when a job is executed, the user can voluntarily set a type of paper to be used, the number of copies, and the like. The communication unit 203, the control unit 204, the storage unit 205, and the operation display unit 206 may be physically included in the image forming apparatus 100 or may be included in the control PC 119. These units may be arranged in an external PC.

Next, an operation in a case where image forming processing is performed on the roll paper 111 in the image forming system 200 will be described. First, the user creates data of the job in an external device, performs print setting of the job, and transmits the job to the image forming apparatus 100 via a communication network. The external device may be the control PC 119 or another information processing apparatus. The control unit 204 receives a job ticket including the data of the job transmitted from the external device, print setting information of the job, and the like via the communication unit 203.

The inspection unit 207 is a device that confirms whether or not printing can be performed on a print image sheet without an ejection failure. A detection pattern at the time of the ejection failure inspection is printed, and the detection pattern is read by a scanner to confirm whether or not there is an ejection failure in a print image. In a case where the ejection failure is detected, the image forming apparatus is stopped. As the inspection method, there are various methods such as a method for printing a detection pattern and reading the detection pattern with a scanner, a method for directly reading a print image with a camera or a scanner and inspecting the print image, and a method for monitoring an ejection state from a nozzle. In the present embodiment, whether or not there is the ejection failure is confirmed by a method for printing a detection pattern and reading the detection pattern with a scanner. The inspection unit 207 can physically correspond to the scanner device 107.

### (Processing Flow of Printing)

Next, a basic flow until the start of printing of the job input to the printing device will be described in order. A flow after the job input to the image forming apparatus 100 is subjected to raster image processing (RIP) by the control unit 204 and enters a RIP completed state will be described.

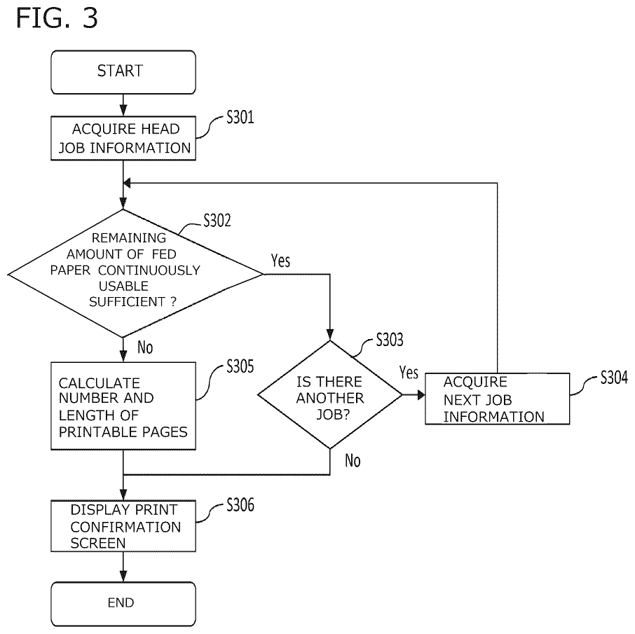

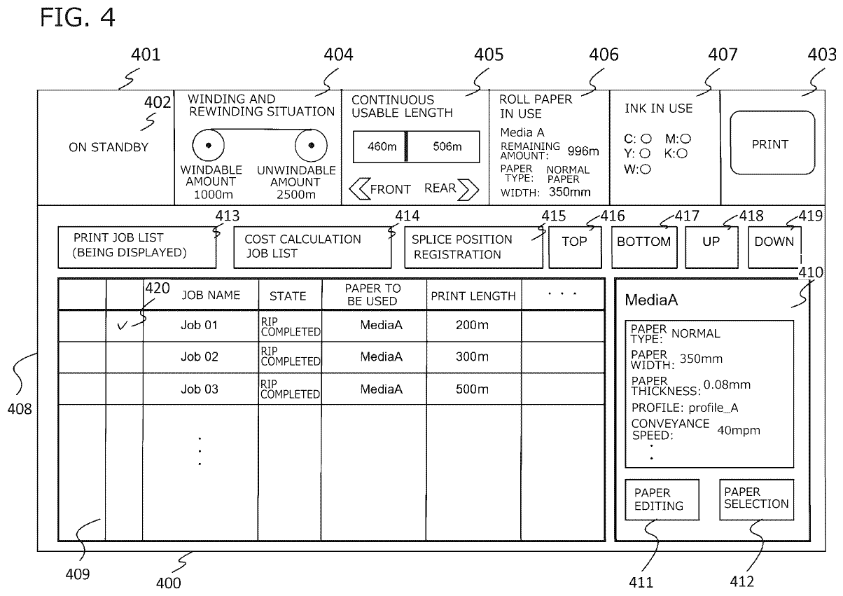

FIG. 3 is a flowchart up to the start of printing in a case where the user gives an instruction about the start of printing. The print start instruction by the user is executed by selecting a job to be printed by a print selection check 420 on the screen illustrated in FIG. 4 and pressing a print button 403.

The processing of this flowchart is executed by the control unit 204 controlling each component of the image forming system 200. The control unit 204 reads various programs such as a system program or a processing program stored in the storage unit 205, loads the programs into the RAM, and executes various kinds of processing according to the loaded programs.

First, in step S301, the control unit 204 acquires head job information and calculates a print length of the job. The print length indicates a length by which the roll paper 111 is consumed when printing is executed according to the job. The control unit 204 sets a value obtained by subtracting a conveyance amount at the time of acceleration and a conveyance amount at the time of deceleration until printing is stopped (a distance required for the roll paper 111 to reach a stopped state from a speed at the time of printing) from a continuous usable length, as the remaining amount of fed paper that can be continuously printed. Here, the conveyance amount at the time of acceleration refers to a distance required for the roll paper 111 to reach a moving speed at the time of printing from the stopped state, and the conveyance amount at the time of deceleration refers to a distance required for the roll paper 111 to reach the stopped state from the speed at the time of printing. The continuous usable length (continuous use length) indicates a length printable on the roll paper 111 set in the image forming apparatus 100 without being caught in the splice.

For example, in a case where the continuous usable length is 460 m, and the conveyance amount at the time of acceleration when conveyance is started and the conveyance amount at the time of deceleration until the conveyance is stopped are each 15 m, the remaining amount of fed paper that can be continuously printed is as follows.
Remaining amount of fed paper that can be continuously printed=460 m−15 m−15 m=430 m

Subsequently, in step S302, the control unit 204 checks whether or not the remaining amount of fed paper that can be continuously printed is sufficient for the print length of the job. In a case where the remaining amount of fed papers that can be continuously printed is sufficient (remaining amount of fed paper≥print length), the control unit 204 updates the remaining amount of fed paper that can be continuously printed by subtracting the print length of the job from the remaining amount of fed paper that can be continuously printed, and proceeds to step S303. On the other hand, in a case where the remaining amount of fed paper that can be continuously printed is insufficient (remaining amount of fed paper<print length), the control unit 204 proceeds to step S305.

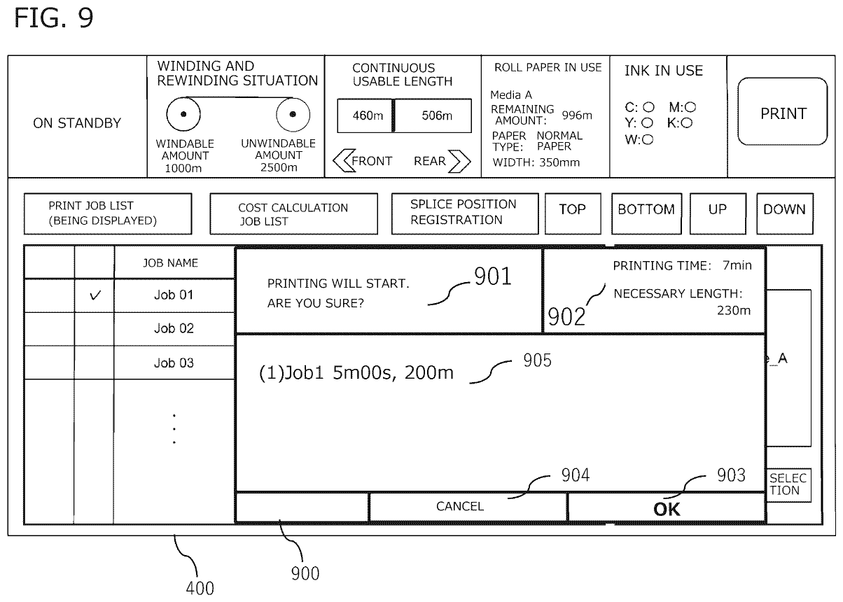

In step S305, the control unit 204 calculates the number and length of pages printable in the job. Subsequently, in step S306, the control unit 204 displays a print confirmation screen. This print confirmation screen will be specifically described with reference to FIG. 9. In S303, the control unit 204 checks whether or not there is another job received from the external device and unprocessed while referring to the memory. In a case where there is another job, the processing proceeds to step S304, and in a case where there is no other job, the processing merges to step S306. In step S304, the control unit 204 acquires next job information, calculates the print length, and executes the processing of step S302 again. After step S306, the control unit 204 ends the processing of this flowchart.

### (User Interface)

FIG. 4 is an example of a user interface (UI) on which a list of print jobs is displayed in the present embodiment. In FIG. 4, a UI screen 400 displays the entire UI displayed on the UI operation panel 101. The UI screen 400 may be displayed as a window in a panel. The UI screen 400 schematically includes a status display area 401 and a work area 408.

In the status display area 401, summary information regarding a state of the image forming apparatus 100, such as a current state of the image forming apparatus 100 and information of a job being printed, is displayed.

An operation status display 402 indicates a status of the image forming apparatus 100. In FIG. 4, the operation status is “on standby” of waiting to print. The operation status includes “stopped”, “printing”, and the like in addition to “on standby”.

When the user presses the print button 403, the print confirmation screen is displayed (FIG. 9). When the user further presses an OK button, printing of the selected print job is started.

In an unwinding or winding status display 404, an unwindable amount and a windable amount are displayed.

In a continuous usable length display 405, a continuous printable length of the recording medium such as the roll paper 111 attached to the image forming apparatus 100 is displayed.

In a recording medium information display 406, a name and a remaining amount of the recording medium attached to the image forming apparatus 100 are displayed.

In an ink state display 407, a type of ink being used and a state of the remaining amount for each ink are displayed.

Contents of the status display area 401 are not limited to the examples illustrated in FIG. 4, and any information desired to be displayed by the user may be displayed.

The work area 408 is a work area for the user to perform an operation. In a case where detailed information related to each piece of information in the status display area 401 is confirmed, each state display region in the status display area 401 is pressed to display the related information in the work area 408.

In a print job list 409, typically, information such as an ID, a current state, a recording medium, and a print length of the print job is displayed. In addition, any information regarding the job may be displayed. The user selects a job in the print job list 409 and presses the print button 403, and thus, the image forming apparatus 100 starts printing.

In a recording medium information display 410, detailed information of the recording medium is displayed. A paper edit button 411 enables editing of the information of the recording medium displayed in the recording medium information display 410. A paper selection button 412 is used in a case where new paper information that is not the currently set paper information is read. Settings read by the paper selection button 412 are displayed in the recording medium information display 406, as the information of the recording medium attached to the image forming apparatus 100.

The user can register a splice position by pressing a splice position registration button 415 while the recording medium information display 406 is being displayed. In the continuous usable length display 405, the continuous printable length is displayed based on splice positional information registered by the user.

A cost calculation job list button 414 is pressed while the print job list 409 is being displayed, and thus, a cost calculation job list is displayed in the work area 408. On the other hand, the print job list button 413 is pressed while the cost calculation job list is being displayed, and thus, the print job list 409 and the operation buttons of the print job are displayed in the work area 408.

In a state where the print job list is displayed, a TOP button 416, a BOTTOM button 417, an UP button 418, and a DOWN button 419, which are buttons for operating A print order of the print jobs, are displayed. The TOP button 416 can move the selected job to the top of the print job list. The BOTTOM button 417 can move the selected job to the end of the print job list. The UP button 418 brings the order of the selected job up by one. The DOWN button 419 lowers the order of the selected job by one. The UI for changing the order of the job is provided in this manner, and thus, it is possible to flexibly align the jobs.

The print selection check 420 is displayed in a row of the job to be printed, which is selected by the user.

### (Splice Registration)

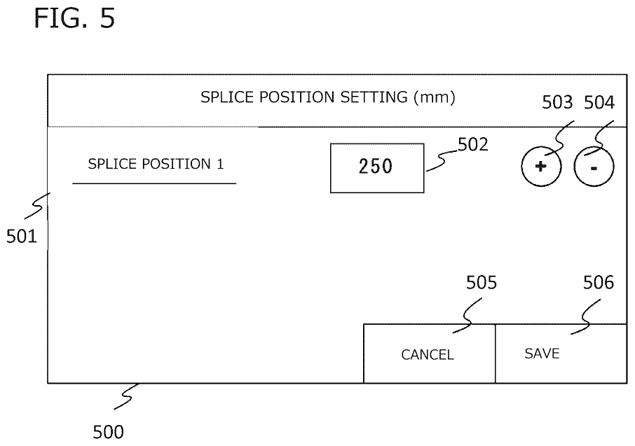

FIG. 5 is an example of a UI screen on which a registration screen for the user to set the splice position is displayed. In the present embodiment, when the user presses the splice position registration button 415 in FIG. 4, the screen transitions. However, the display method of the splice position registration UI is not limited thereto.

The splice position registration screen 500 has a work region 501 for splice position setting. In the work region 501, a splice position input region 502, an add button 503 for adding the splice position input region, a delete button 504 for deleting the splice position input region, a cancel button 505 for canceling input information, and a save button 506 for saving input information are displayed.

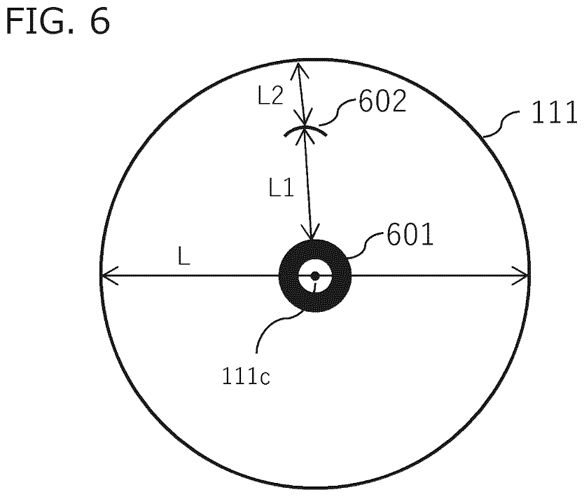

The splice positional information input to the splice position input region 502 by the user will be described with reference to FIG. 6. FIG. 6 is a sectional view of roll paper 111 set in the paper feeding device 104. In FIG. 6, the roll paper 111 is wound around the paperboard core 601 to have a section of a circular shape, and a splice tape end portion 602 is exposed in a section. An outer diameter in a line passing through a center 111c of a circle of the section of the roll paper 111 is defined as L.

The user detects a splice position distance L1 which is a distance from the splice tape end portion 602 to the paperboard core 601 in the section of the circular shape of the cylindrical roll paper 111. The detection method is any method, and the measurement may be performed by using a measure, or the distance may be calculated from a captured image. When the detected splice position distance L1=250 mm, the user registers the splice position as illustrated in FIG. 6. The remaining amount detection sensor 121 detects that the outer diameter L of the roll paper 111 set in the paper feeding device 104 is 330 mm. As a result, the control unit 204 can calculate the continuous usable length. A distance from the splice tape end portion 602 to an outer periphery of the roll paper is L2.

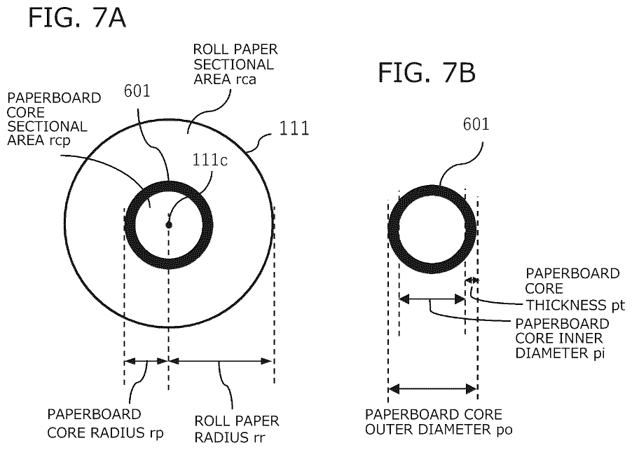

FIGS. 7A and 7B are diagrams for explaining a method for calculating a roll paper length rln from a roll paper radius rr. The control unit 204 calculates the roll paper length from the roll paper radius rr on the basis of the following Calculation Expressions (1) to (4). Here, the roll paper radius rr indicates a distance from the center 111c of the circle to the outer periphery of the roll paper 111, a paperboard core radius rp indicates a distance from the center 111c of the circle to the outer periphery of the paperboard core 601, a roll paper sectional area rca indicates a sectional area of the roll paper 111, a paperboard core sectional area rcp indicates a sectional area of the paperboard core 601, a paperboard core inner diameter pi indicates an inner diameter of the paperboard core 601, a paperboard core outer diameter po indicates an outer diameter of the paperboard core 601, and a paperboard core thickness pt indicates a thickness of the paperboard core 601 in the section. A roll paper thickness rt can be acquired as a specification of the roll paper 111.

$$Paperboard core radius rp = ( paperboard core inner diameter pi + paperboard core thickness p t + paperboard core thickness p t ) \div 2 \qquad ( 1 )$$

$$Paperboard core sectional area rcp = paperboard core radius rp \times paperboard core radius rp \times circular constant π \qquad ( 2 )$$

$$Roll paper sectional area rca = roll paper radius rr \times roll paper radius rr \times circular constant π \qquad ( 3 )$$

$$Roll paper length rln = ( roll paper sectional area rca - paperboard core sectional area rcp ) \div roll paper thickness rt \qquad ( 4 )$$

For example, in a case where the paperboard core inner diameter pi is 76 mm, the paperboard core thickness pt is 5 mm, the roll paper thickness rt is 80 μm (0.08 mm), and the roll paper outer diameter L is 330 mm, Expressions (1) to (4) are as follows (rounded off decimal points).

$$Paperboard core radius rp = ( 76 + 5 + 5 ) \div 2 = 43 mm$$

$$Paperboard core sectional area rcp = 43 \times 43 \times 3.14 = 5806 {mm}^{2}$$

$$Roll paper sectional area rca = 165 \times 165 \times 3.14 = 85487 {mm}^{2}$$

$$Roll paper length rln = ( 85487 - 5806 ) \div 0.08 = 996 m$$

The roll paper radius (roll paper radius rrs to the splice position) in the section from the center of the circle to the splice tape end portion is calculated on the basis of the following Calculation Expression (5).

$$Roll paper radius rrs to splice position = length L 1 from splice tape end portion to paperboard core + ( inner paperboard core diameter pi \div 2 ) + paperboard core thickness p t \qquad ( 5 )$$

For example, in a case where the length L1 from the splice tape end portion 602 to the paperboard core 601 is 250 mm,

$$roll paper radius rrs to splice position = 80 + ( 76 / 2 ) + 5 = 123 mm ,$$

and when this roll paper radius is applied to Expressions (3) and (4),

$$roll paper sectional area to splice position = 123 \times 123 \times 3.14 = 47505 {mm}^{2} ,$$

$$roll paper length from paperboard core to splice tape end portion 602 = ( 47 \; 505 - 5806 ) \div 0.08 = 521 m .$$

In order to avoid printhead rubbing of the recording units 115 and 116 and to stably convey the recording units, in the present embodiment, 15 m before and after the splice tape end portion 602 is defined as an unprintable length, but may be a user setting value, and the present disclosure is not limited thereto.

As described above, the continuous usable length from the outer periphery of the roll paper 111 to the splice tape end portion 602 is obtained as follows.

$$Continuous usable length = roll paper length - roll length from splice tape end portion to paperboard core - unprintable region = 996 - 521 - 15 = 460 m$$

The control unit 204 displays the continuous usable length obtained in this manner on the continuous usable length display 405 of FIG. 4. Here, since a region from the splice position to the outer periphery of the roll paper is used first, 460 m is displayed on a “front” side, and since a region from the splice position to the paperboard core is used later, 506 m is displayed on a “rear” side.

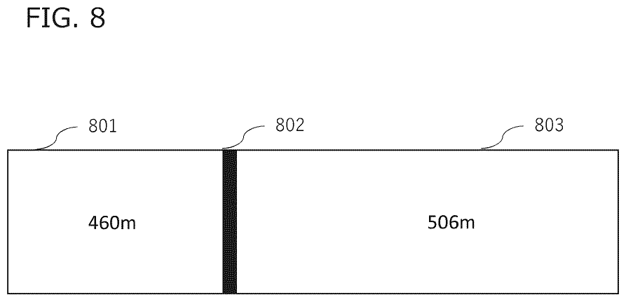

An enlarged view of this continuous usable length display 405 is illustrated in FIG. 8. In FIG. 8, a continuous usable length 801 from a splice position 1 registered by the user, an unprintable length 802, and a continuous usable length 803 to the splice position 1 to the paperboard core 601 are set by using the UI of FIG. 5.

In the present embodiment, three jobs of Job01, Job02, and Job03 are represented as being in an RIP completed state.
Paper of Job01 is MediaA, and print length is 200 m
Paper of Job02 is MediaA, and print length is 300 m
Paper of Job03 is MediaA, and print length is 500 m

The conveyance amount at the time of acceleration and the conveyance amount at the time of deceleration until printing is stopped are defined as 15 m.

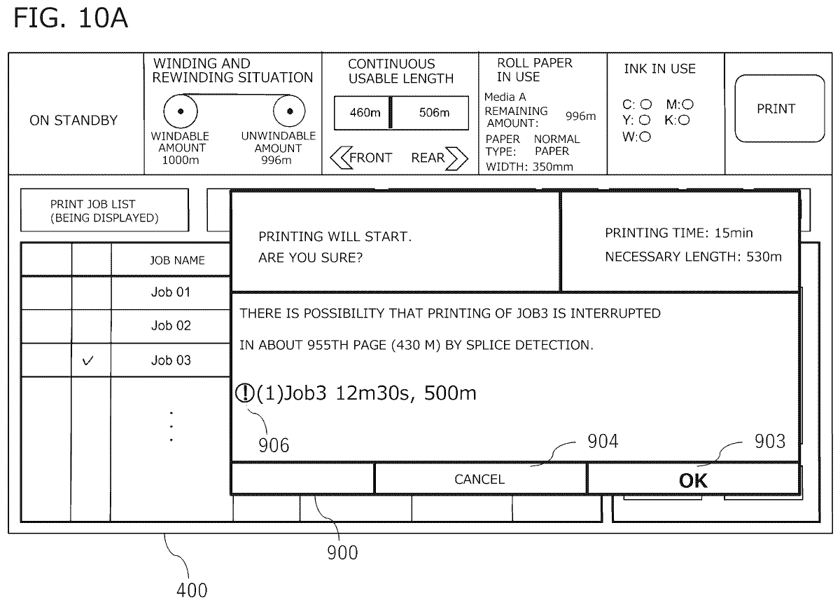

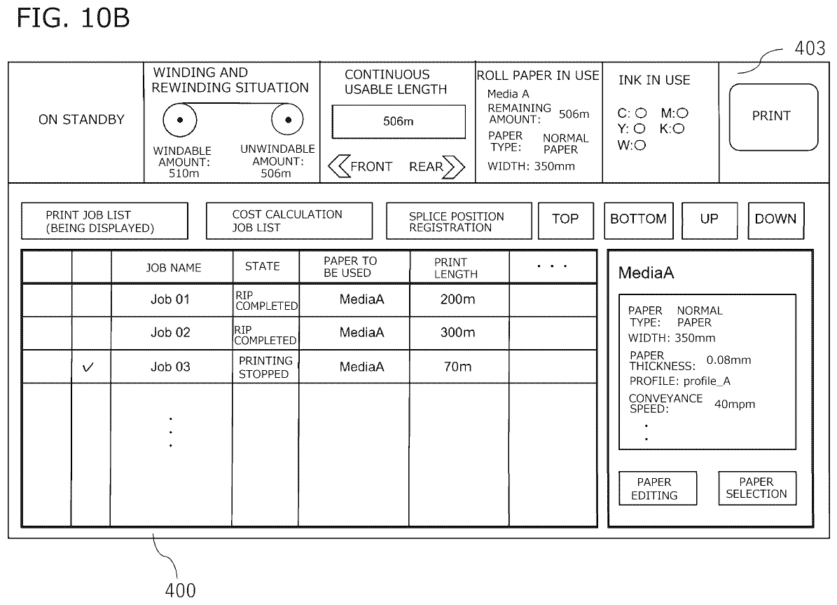

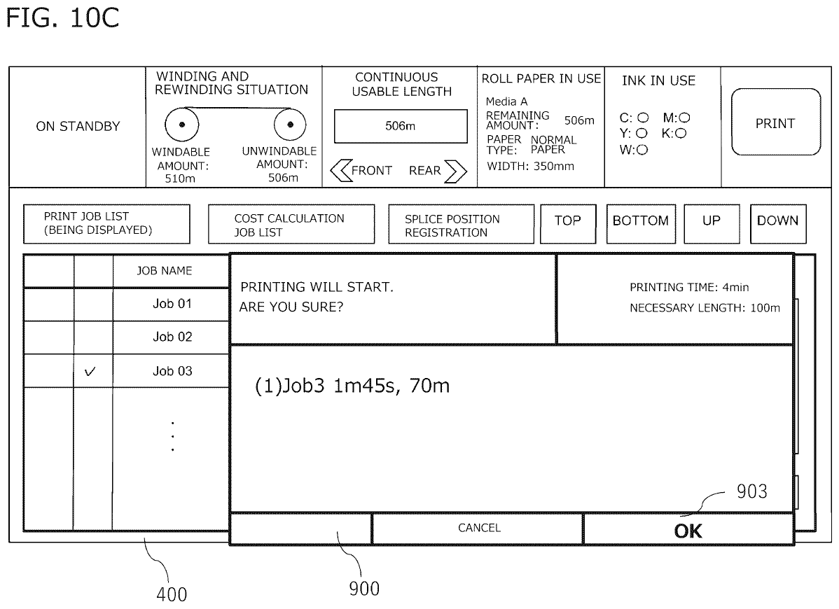

FIG. 9 is an example of a UI screen for print confirmation after the print button 403 is pressed. In FIG. 9, a print confirmation screen 900 displays the entire confirmation screen. A message display area 901 displays a confirmation message for starting printing. A time and length display area 902 displays a length necessary for printing and a printing time. An OK button 903 indicates a button pressable by the user who completes the confirmation, and printing is started by being pressed. In a case where the user desires to stop printing, the user presses a cancel button 904. In a case where there is a warning message for the user, a warning display area 905 displays the warning message, and further displays the print length and the printing time of each selected job. As illustrated in FIG. 10A, a warning mark 906 may be displayed for a target job for which a warning is displayed.

FIG. 9 illustrates the print confirmation screen 900 in a case where the remaining amount of fed paper is 996 m and the job of Job01 is selected in the print selection check 420. The print length of Job01 becomes 200 m, and continuous printing can be performed. On the print confirmation screen 900, a warning message for confirmation before the start of printing is displayed.

The user presses the OK button 903 in this state, and thus, printing is started. When printing is started, the recording unit 115 and the printing device 102 move to an ink ejection position on the roll paper 111 in preparation for ejection. The paper feeding device 104 starts acceleration conveyance for the roll paper 111, and after a conveyance state is stabilized, the printing device 102 starts ejecting for printing of Job01. Since there is no splice during the printing of Job01, printing is performed up to a last page of Job01. After printing of the last page of Job01 is completed, the printing device 102 moves away from the ejection position and returns to a standby position. Thereafter, a final printed matter of Job01 is wound up to the paper discharging device 105, and then printing is ended.

FIGS. 10A to 10C are examples of the UI screen for print confirmation after the print button 403 is pressed. FIG. 10A illustrates a print confirmation screen in a case where the remaining amount of fed paper is 996 m and the job of Job03 is selected in the print selection check 420. Since the print length of Job03 is 500 m and the continuous usable length is insufficient, a warning message before the start of printing and a warning mark 906 for Job03 are displayed.

In a case where the user desires to change the job content (for example, the number of pages is changed, or another job that can be continuously printed is reselected) by viewing the warning, the user may press the cancel button 904. In order to make the continuous usable length sufficient, the user may cause the paper feeding device 104 to convey a splice portion to the paper discharging device 105 by operating the operation unit 206b, or may replace the roll paper 111. At the time of control, for example, it may be determined whether or not one recording job is recorded across the splice on the basis of the splice information, and a warning may be issued to the user in a case where it is determined that there is recording across the splice.

On the other hand, in a case where the user presses the OK button 903, printing is started. The splice is detected by the splice detection sensor 123 during the printing of Job03, and the ejection of the printing device 102 is immediately interrupted when 430 m of Job03 is printed. The printing device 102 moves away from the ejection position and returns to the standby position. The paper feeding device 104 automatically conveys the splice to the paper discharging device 105, and ends the printing of Job03.

At this time, as illustrated in FIG. 10B, a “printing stopped” state is displayed in a state display field of Job03. The continuous usable length of the roll paper 111 is 506 m. Thereafter, in a case where the user presses the print button 403 again, the print confirmation screen 900 in FIG. 10C is displayed. A remaining print length of Job03 becomes 70 m, and continuous printing can be performed. When the user presses the OK button 903 in this state, the printing processing proceeds similarly to the case of FIG. 9 described above.

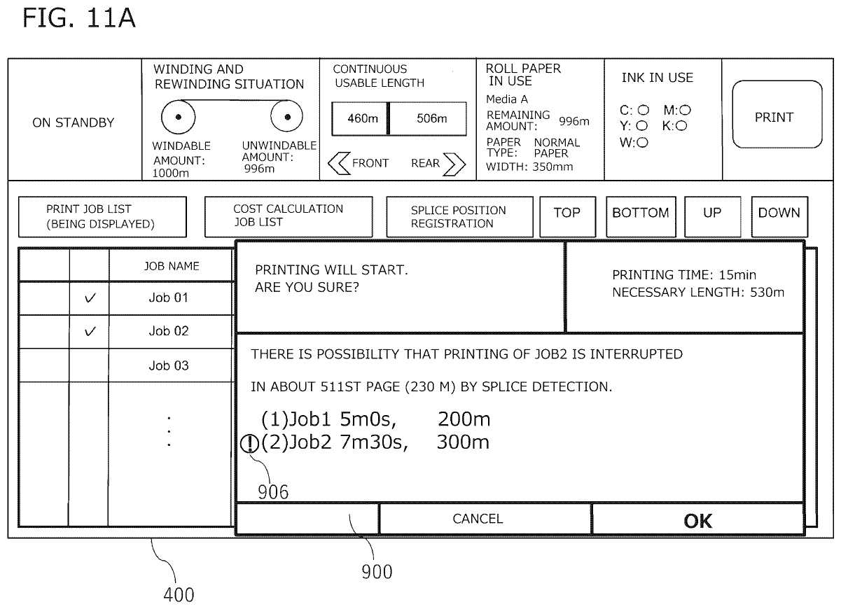

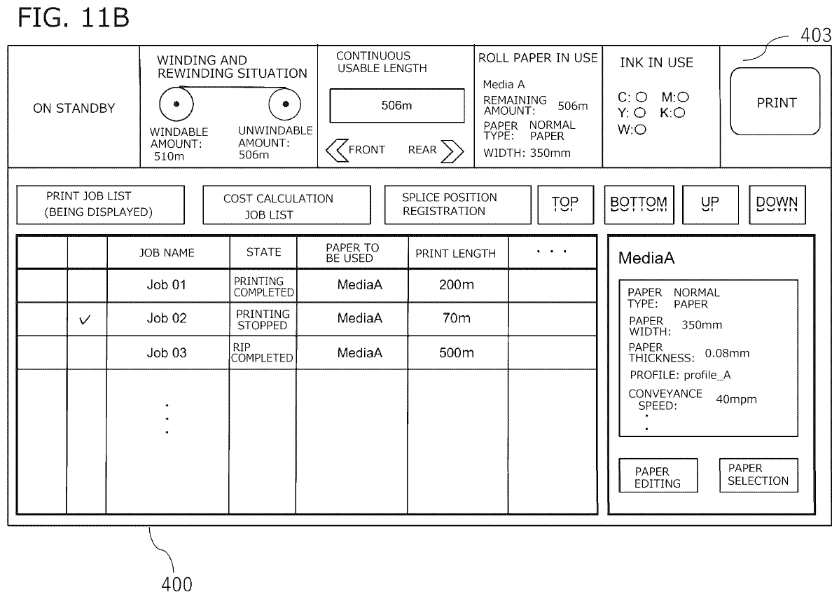

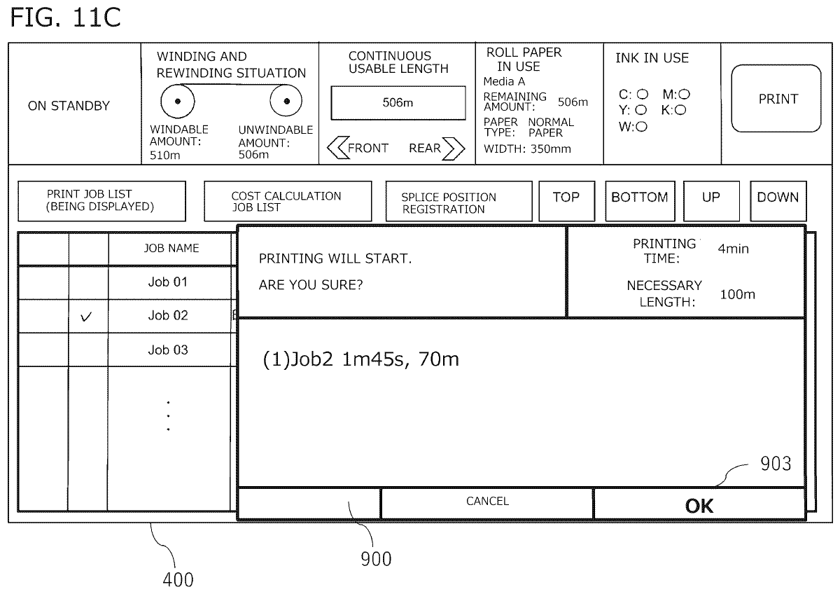

FIGS. 11A to 11C are examples of the UI screen for print confirmation after the print button 403 is pressed. FIG. 11A illustrates the print confirmation screen 900 in a case where the remaining amount of fed paper is 996 m and the jobs of Job01 and Job02 are selected in the print selection check 420. Since Job01 and Job02 have a total print length of 500 m, the continuous usable length is insufficient. Thus, a warning message before the start of printing and a warning mark 906 for Job02 are displayed.

In a case where the user presses the OK button 903 in this state, printing is started. The splice is detected by the splice detection sensor 123 during the printing of Job02, and printing is immediately interrupted when 230 m of Job02 is printed. The paper feeding device 104 automatically conveys the splice to the paper discharging device 105, and the printing of Job02 is ended.

At this time, as illustrated in FIG. 11B, a “printing stopped” state is displayed in the state display field of Job02. The continuous usable length of the roll paper 111 is 506 m. Thereafter, when the user presses the print button 403 again, the print confirmation screen 900 in FIG. 11C is displayed. A remaining print length of Job02 becomes 70 m, and continuous printing can be performed. When the user presses the OK button 903 in this state, the printing processing proceeds similarly to the case of FIGS. 9 to 10C described above.

As described above, according to the configuration of the present embodiment, in the image forming system, the continuous usable length is obtained from the splice positional information, and thus, it is possible to determine whether or not job printing is interrupted by the splice before the start of printing. As a result, the user can appropriately arrange the print job by grasping the continuous usable length in advance. A loss of the roll paper can be reduced.

Here, in the technology of the related art in which printing is interrupted at the splice portion, since a consolidated output cannot be obtained, various problems are caused. For example, since the joint cannot be scraped by a label finisher system (post-processing machine such as die cutting, scraping, or winding), post-processing is interrupted. In a case where the splice is mixed into a delivered product, there is a problem that splice detection processing is required even in an automatic labeling machine (for example, a labeling machine). On the other hand, according to the technology of the present disclosure, since products are collectively obtained, the label finisher system does not need to process the joint, and the post-processing is not interrupted. Since the splice is not mixed into the product, splice processing is unnecessary even in an automatic labeling machine. As described above, various effects can be obtained by preventing the splice from being included in a job scheduled to be continuously printed.

### Second Embodiment

Hereinafter, a second embodiment of the present disclosure will be described. Configurations of an image forming system 200 and an image forming apparatus 100 according to the second embodiment are similar to those described in the first embodiment. Hereinafter, portions different from those of the first embodiment will be mainly described, and redundant description will be omitted.

In the first embodiment, the control to give the warning in a case where there is a job having a possibility of being interrupted by the splice on the basis of the continuous usable length and information of the plurality of jobs has been described. On the other hand, in the second embodiment, it is possible to perform control to propose an optimum print order to the user on the basis of the continuous usable length and the information of the plurality of jobs.

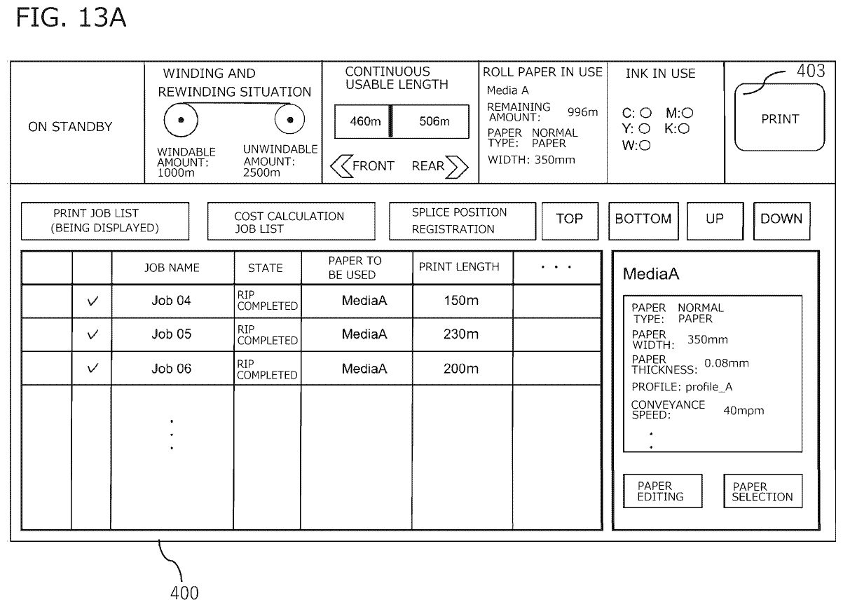

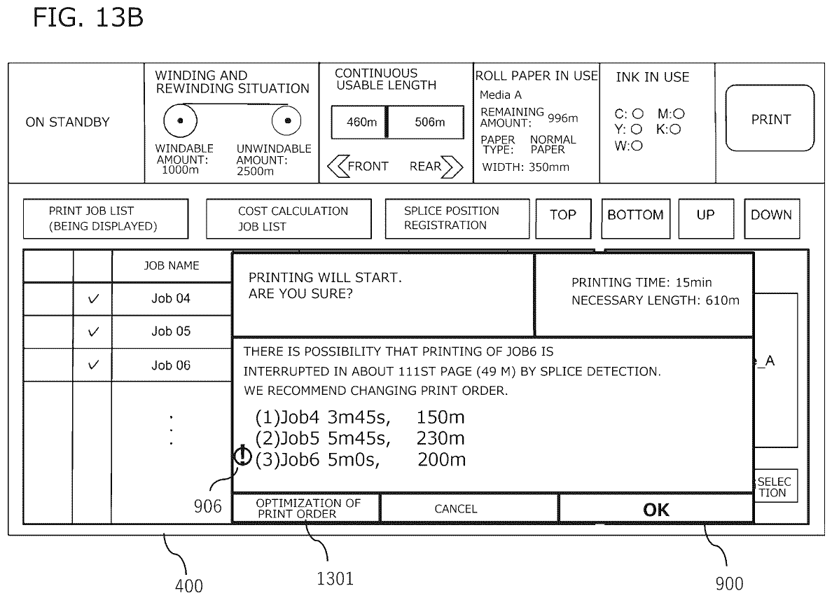

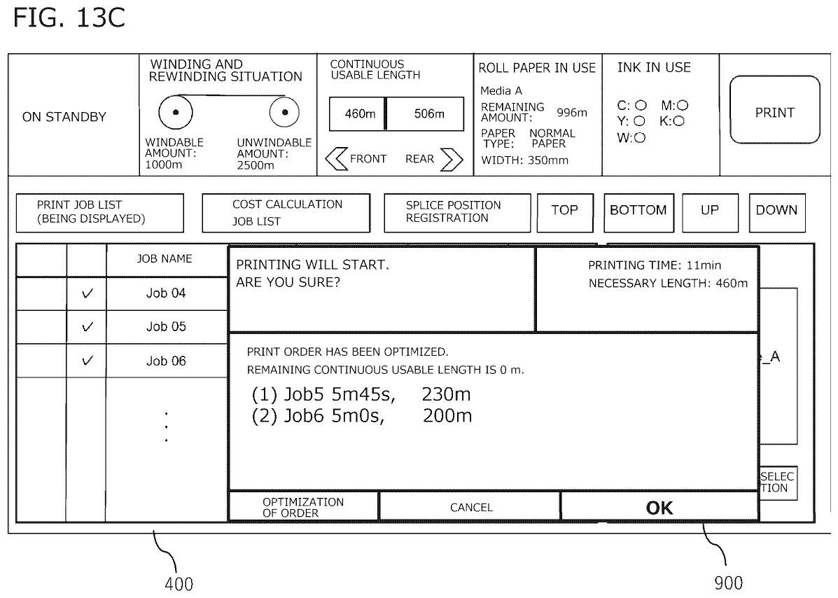

The UI screen 400 of the present embodiment illustrated in FIG. 13A indicates that three jobs of Job04, Job05, and Job06 are selected in a state where RIP is completed for the jobs of Job04, Job05, and Job06. Here, the contents of each job are as follows.
Job04: paper is MediaA, print length is 150 m
Job05: paper is MediaA, print length is 230 m
Job06: paper is MediaA, print length is 200 m.

As illustrated in FIG. 13A, the remaining amount of fed paper is 996 m, and the continuous usable length is 460 m. The conveyance amount at the time of acceleration and the conveyance amount at the time of deceleration until printing is stopped are defined as 15 m.

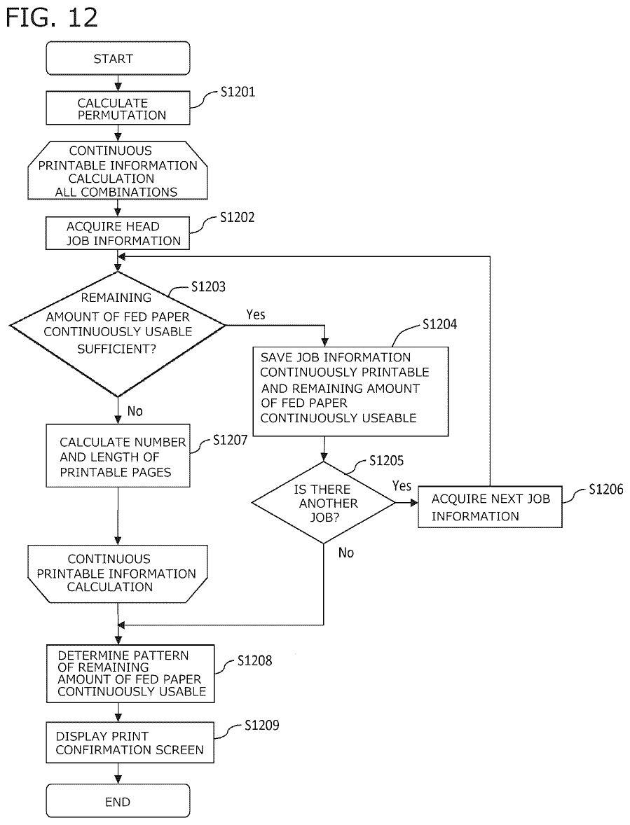

FIG. 12 is a flowchart until the start of printing in a case where the print button 403 is pressed in FIG. 13A. In the processing of this flowchart, the CPU of the control unit 204 reads various programs such as a system program or a processing program stored in the storage unit 205, loads the programs into the RAM, and executes various kinds of processing according to the loaded programs.

Since step S1202, step S1203, step S1205, step S1206, step S1207, and step S1209 in FIG. 12 are similar to step S301, step S302, step S303, step S304, step S305, and step S306 in FIG. 3 described in the first embodiment, respectively, the description thereof is incorporated.

In step S1201, permutation processing is performed on the selected plurality of jobs. In the case of three jobs of the present embodiment, six combinations are generated as permutation results as follows.
Combination 1: Job04, Job05, Job06
Combination 2: Job04, Job06, Job05
Combination 3: Job05, Job04, Job06
Combination 4: Job05, Job06, Job04
Combination 5: Job06, Job04, Job05
Combination 6: Job06, Job05, Job04

Subsequent processing will be described by using a permutation result of combination 1. In step S1202, the control unit 204 acquires information of the Job04 at the head and calculates the print length. In addition, a value obtained by subtracting the conveyance amount at the time of acceleration and the conveyance amount at the time of deceleration until printing is stopped from the continuous usable length is set as the remaining amount of fed paper that can be continuously printed.

$$Remaining amount of fed paper that can be continuously printed = 460 m - 15 m - 15 m = 430 m$$

$$Length of Job 04 = 150 m$$

Subsequently, in step S1203, the control unit 204 checks whether or not the remaining amount of fed paper that can be continuously used is sufficient for the print length of the job. In a case where the remaining amount of fed paper that can be continuously printed is sufficient (S1203=Yes), the remaining amount of fed paper that can be continuously printed is updated by subtracting the print length of the job from the remaining amount of fed paper that can be continuously printed, and the processing proceeds to step S1204. On the other hand, in a case where the continuous usable length is insufficient (S1203=No), the processing proceeds to step S1207.

The control unit 204 determines that the remaining amount of fed paper that can be continuously printed is larger than the length of Job04, sets a value obtained by subtracting the length of Job04 from the remaining amount of fed paper that can be continuously printed, as the remaining amount of fed paper that can be continuously printed, and proceeds to step S1204.

$$Remaining amount of fed paper that can be continuously printed = 430 m - 150 m = 280 m$$

In step S1204, the control unit 204 saves the job information of Job04 that can be continuously printed and the remaining amount of fed paper that can be continuously used by 280 m, and proceeds to step S1205.

In step S1205, the control unit 204 checks whether or not there is another job. Since there is next job Job05 (S1205=Yes), the processing proceeds to step S1206.

In step S1206, the control unit 204 acquires information of Job05, which is the next job, and calculates the print length.

$$Length of Job 05 = 230 m$$

Subsequently, the processing returns to step S1203. The control unit 204 determines that the remaining amount of fed paper that can be continuously printed is larger than the length of Job05 (S1203=Yes), sets a value obtained by subtracting the length of Job05 from the remaining amount of fed paper that can be continuously printed, as the remaining amount of fed paper that can be continuously printed, and proceeds to step S1204.

$$Remaining amount of fed paper that can be continuously printed = 280 m - 230 m = 50 m$$

In step S1204, the control unit 204 saves the job information of Job05 that can be continuously printed and the remaining amount of fed paper that can be continuously used by 50 m, and proceeds to step S1205.

In step S1205, since there is next job Job06, the control unit 204 proceeds to step S1206.

In step S1206, the control unit 204 acquires the information of Job06 and calculates the print length.
Length of Job06=200 m

Subsequently, the processing returns to step S1203. The control unit 204 determines that the remaining amount of fed paper that can be continuously printed is smaller than the length of Job06 (S1203=No), and proceeds to step S1207.

In step S1207, the number of pages and the length that can be printed by the job of Job06 are calculated.

As described above, the job information that can be continuously printed and the remaining amount of fed paper that can be continuously used in Combination 1 of the permutation result are as follows.
Job information that can be continuously printed: Job04 and Job05
Remaining amount of fed paper that can be continuously used: 50 m

The job information that can be continuously printed and the remaining amount of fed paper that can be continuously used for remaining Combination 2 to Combination 6 are calculated as follows.

### Combination 1:

Job information that can be continuously printed: Job04 and Job05
Remaining amount of fed paper that can be continuously used: 50 m

### Combination 2:

Job information that can be continuously printed: Job04 and Job06
Remaining amount of fed paper that can be continuously used: 110 m

### Combination 3:

Job information that can be continuously printed: Job05 and Job04
Remaining amount of fed paper that can be continuously used: 50 m

### Combination 4:

Job information that can be continuously printed: Job05 and Job06
Remaining amount of fed paper that can be continuously used: 0 m

### Combination 5:

Job information that can be continuously printed: Job06 and Job04
Remaining amount of fed paper that can be continuously used: 110 m

### Combination 6:

Job information that can be continuously printed: Job06 and Job05
Remaining amount of fed paper that can be continuously used: 0 m

In step S1208, the control unit 204 sets, as an optimized pattern, job information that can be continuously printed and has a minimum value from the saved remaining amount of fed paper that can be continuously used for each combination. In a case where there are a plurality of minimum values, a first found value is set as the optimized pattern. As described above, the job information that can be continuously printed for Combination 4 is the optimized pattern.

In step S1209, the control unit 204 displays a print confirmation screen 900 illustrated in FIG. 13B. Thereafter, the control unit 204 ends the processing of this flowchart.

FIG. 13B illustrates the print confirmation screen 900 in a case where Job04, Job05, and Job06 are selected. A total print length of Job04, Job05, and Job06 is 580 m, and the continuous usable length is insufficient. Therefore, the control unit 204 displays a warning message before the start of printing and a warning mark 906 for the job 06. Here, an optimization button 1101 of the print order is displayed on the UI screen 400.

FIG. 13C illustrates the UI screen 400 after the user presses the optimization button 1101. Here, the print confirmation screen 900 indicates that optimization is performed so as to set the print orders of Job05 and Job06 as in optimum Combination 4 described above.

As described above, in the present embodiment, in the image forming system, it is possible to improve a usage rate of the continuous usable length by proposing the optimum print order for the continuous usable length to the user. As a result, the products can be collectively printed as much as possible. Accordingly, the loss of roll paper can also be reduced.

### Third Embodiment

In the first embodiment, as described with reference to FIG. 6, the splice positional information is defined as a length measured by the user from the splice tape end portion 602 to the paperboard core 601. The continuous usable length was obtained on the basis of the splice positional information. However, the method for defining the splice position is not limited thereto.

In the present embodiment, the splice positional information and the continuous usable length are acquired on the basis of information provided by a paper manufacturer or the like. For example, the paper manufacturer produces the roll paper 111 by using a slitter machine or a rewinder machine. At this time, the roll paper 111 is produced by installing original material in the rewinder machine and rewinding paper on the basis of a requested length (numerical value of a meter). In a procedure of rewinding, the paper manufacturer can acquire information of a wound length from the rewinder machine. Here, in a case where a length of the original material is insufficient for the requested length, it is necessary to connect the plurality of roll papers 111 with a tape. In a case where such connecting is performed, the length (numerical value of the meter) already wound before the connection becomes the continuous usable length. An information provider is not limited to a manufacturer such as a paper manufacturer, and may be a person who can acquire information at the time of manufacturing the roll paper 111, and may be, for example, a trading company.

In a case where connection needs to be performed multiple times, a continuous usable length between splices can be obtained from a difference from a previously recorded continuous usable length. The paper manufacturer can also manage and output the continuous usable length information according to the joint information (splice information).

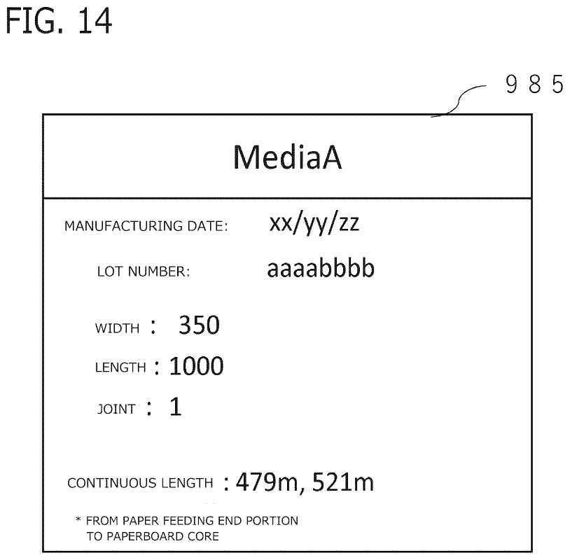

FIG. 14 illustrates an example of a label 985 attached to the roll paper 111 delivered from the paper manufacturer. In the label 985 illustrated in FIG. 14, information of the number of joints is also described in addition to the width and length of the roll paper 111. There may be information of the continuous usable length from the paper feeding end portion to the paperboard core 601. For example, as illustrated in FIG. 14, in a case where there is one joint, the continuous usable length from the paper feeding end portion to the splice is 479 m, and the continuous usable length from the splice to the paperboard core 601 is 521 m.

In the first embodiment, as illustrated in FIG. 6, it is assumed that the user inputs the length measured from the splice tape end portion 602 to the paperboard core 601 to the splice position input region 502 in FIG. 5, but there may be other measurement methods. For example, in a case where the positional information of the splice of the roll paper 111 is provided from the paper manufacturer, the positional information of the splice may be input.

A method for providing the information from the manufacturer or the like is not limited to the label 985. For example, the positional information of the splice may be provided by a method such as a tangible recording medium, an arrangement on a web server, or a two-dimensional information recording medium such as a barcode or a QR code (registered trademark). For example, in a case where the manufacturer provides the splice information with a QR code, when the user reads the QR code, the splice information may be automatically reflected on the registration screen for setting the splice position in FIG. 5.

According to the technology described in the present specification, the loss of the paper can be reduced. The technology described in the present specification may contribute to the realization of a sustainable society such as a decarbonized and recycling society.

According to the present disclosure, the splice can be appropriately managed in continuous printing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196704, filed Nov. 11, 2024, which is hereby incorporated by reference herein in its entirety.

What is claimed is:

1. A recording device comprising:
a holding unit configured to hold a roll sheet in which a recording medium is wound in a roll shape;
a conveyance unit configured to unwind and convey the recording medium from the roll sheet held by the holding unit;
a recording unit configured to perform recording on the recording medium conveyed by the conveyance unit; and
a control unit configured to perform the conveyance of the recording medium by the conveyance unit and control of the recording by the recording unit,
wherein the recording device further includes
a setting unit configured to set splice information related to a position of a splice which is a joint of the roll sheet held by the holding unit, and
the control unit performs the control by the splice information set by the setting unit.

2. The recording device according to claim 1,
wherein the control unit warns a user in a case where one recording job is recorded across the splice on a basis of the splice information.

3. The recording device according to claim 1,
wherein, when a plurality of recording jobs are executed, the control unit changes an order of a recording job recorded in the recording unit on a basis of the splice information.

4. The recording device according to claim 2,
wherein the control unit acquires a continuous usable length that is a length continuously printable on the recording medium without crossing the splice on a basis of the splice information.

5. The recording device according to claim 4,
wherein the control unit acquires a print length that is a length of the recording medium used when a print job is executed on a basis of the print job, and performs the control on a basis of the continuous usable length and the print length.

6. The recording device according to claim 5,
wherein the control unit calculates a position of the splice such that the recording by the recording unit is not performed on the splice during the print job on a basis of the continuous usable length and the print length before start of the print job, and executes the print job after the recording medium is conveyed to the calculated position.

7. The recording device according to claim 6,
wherein, when the position of the splice is calculated, the control unit uses a value obtained by subtracting a conveyance amount at a time of acceleration when the conveyance of the recording medium is started and a conveyance amount at a time of deceleration when the conveyance of the recording medium is stopped from the continuous usable length.

8. The recording device according to claim 1,
wherein the control unit acquires the splice information on a basis of input information by a user.

9. The recording device according to claim 1,
wherein the control unit acquires the splice information on a basis of information provided to a manufacturer of the recording medium.

10. The recording device according to claim 4,
wherein the control unit uses, as the splice information, at least information indicating a radius in a section of a circular shape of the recording medium wound in a roll shape and information corresponding to a distance from a center of the circular shape to the splice.

11. The recording device according to claim 10,
wherein the recording medium is wound in a roll shape with a tubular member as a center, and
the control unit acquires the continuous usable length on a basis of information indicating an outer diameter of the tubular member and information corresponding to a distance from the center of the circular shape to the splice.
